(19) United States
(12) Patent Application Publication
(10) Pub. No.: US 2022/0076231 A1
(43) Pub. Date: Mar. 10, 2022

(54) SYSTEM AND METHOD FOR ENRICHMENT OF TRANSACTION DATA

(71) Applicant: JPMorgan Chase Bank, N.A., New York, NY (US)

(72) Inventors: Stephen FARRELL, Lincoln University, PA (US); Manish MISHRA, West Windsor, NJ (US); Michael NESTEL, Princeton Junction, NJ (US); Brent WARSHAW, Fairfield, CT (US); Robert J. RAPPA, Manalapan, NJ (US); Maria Stella NG, Newark, DE (US)

(21) Appl. No.: 17/455,476

(22) Filed: Nov. 18, 2021

Related U.S. Application Data
(63) Continuation-in-part of application No. 15/627,678, filed on Jun. 20, 2017.
(60) Provisional application No. 62/352,329, filed on Jun. 20, 2016.

(51) Int. Cl. G06Q 20/32; G06Q 20/40; G06Q 20/38

(52) U.S. Cl. CPC G06Q 20/3224; G06Q 20/3827; G06Q 20/405; G06Q 20/4014

(57) ABSTRACT

The invention relates to a computer-implemented system and method for uniquely identifying a merchant from a transaction string transmitted by a payment network. The method may comprise the steps of: gathering input information, including receiving the transaction string from the payment network and receiving from a data provider a data set containing merchant information; cleansing the transaction string; executing a match process between the transaction string and the data set from data provider to find the best merchant match; wherein the match process comprises using a logistic regression model, a waterfall process, or an override process; consolidating results of the matching process to create a master lookup table having attributes from transaction strings mapped to matching merchant attributes from the data provider data set; and executing a transaction tagging process on a received transaction string.

### RELATED APPLICATIONS

This application is a Continuation-In-Part of U.S. application Ser. No. 15/627,678, filed Jun. 20, 2017, entitled “System and Method for Enrichment of Transaction Data,” which claims priority to U.S. Application No. 62/352,329, filed Jun. 20, 2016, entitled “System and Method for Enrichment of Transaction Data,” both of which are hereby incorporated by reference.

### FIELD OF THE INVENTION

The present invention relates generally to the processing of financial transaction data, and more particularly to a system and method for uniquely identifying a merchant or counterparty from a transaction string generated by a payment network to enable enhanced data analytics and reporting.

### BACKGROUND

Issuers of credit cards and debit card have access to a variety of data on credit card and debit card transactions. In connection with each transaction, the card issuer receives a transaction string from the payment network (e.g., VISA or MasterCard) that includes some limited information on the merchant making the sale. Unfortunately, the merchant information in the transaction string has a number of drawbacks. An example of this merchant information in the transaction string might be “WM SUPERCENTER #4264 ORO VALLEY Ariz.” This merchant information does not lend itself to easy identification of the merchant, the merchant's physical address, corporate affiliates, or any other information. In this example, the merchant is actually Wal-Mart Stores, Inc. and the merchant's physical address is 7951 North Oracle Road, Oro Valley, Ariz. 85704-6346. Identifying the merchant and its physical address could provide significant benefits to the card issuer, such as the ability to compile data on transactions conducted at the merchant by location and the ability to link and associate a large amount of other data on the merchant to various credit card and debit card transactions. But this data correlation is not currently available because there is no effective way to identify with any confidence the exact merchant or merchant location based on the transaction string.

FIG. 1 illustrates an example of a statement from a known credit card issuer that includes a business name and address. However, the credit card issuer in the FIG. 1 example (in this case, American Express) is also the owner of the payment network. Hence, it already has control over the merchant name and address information as the owner of the payment network and does not need to derive that information from the transaction string in accordance with exemplary embodiments of the present invention.

It would be desirable, therefore, to have a system and method for identifying merchant names and addresses from transaction strings generated from credit card and debit card transactions.

Financial institutions also face similar challenges in connection with other types of transactions, such as automated clearinghouse (ACH) transactions, wire transactions, and online bill pay transactions. These types of transactions generate similar transaction strings that provide only limited information on the merchant, originator, or counterparty to the transaction. It would be desirable, therefore, to have a system and method for identifying merchants, originators and counterparties from automated clearinghouse (ACH) transactions, wire transactions, and bill pay transactions.

### SUMMARY

According to one embodiment, the invention relates to a computer-implemented system and method for uniquely identifying a merchant from a transaction string transmitted by a payment network. The method may be conducted on a specially programmed computer system comprising one or more computer processors, electronic storage devices, and networks. The method may comprise the steps of: gathering input information, including receiving the transaction string from the payment network, the transaction string including merchant information and receiving from a data provider a data set containing merchant information; processing the transaction string to discard invalid city data; executing a match process between the transaction string and the data set from data provider to find the best merchant match; wherein the match process comprises using a logistic regression model for transaction strings having a valid city, using a waterfall process for transaction strings with no city or an invalid city, and using an override process for transactions involving travel or predefined merchants; consolidating results of the matching process to create a master lookup table having attributes from transaction strings mapped to matching merchant attributes from the data provider data set; and executing a transaction tagging process on a received transaction string by matching the received transaction string against the master lookup table using a hash identifier, wherein the hash identifier is created based on the transaction string and is compared to a hash identifier in the master lookup table.

The invention also relates to a computer implemented system for uniquely identifying a merchant from a transaction string transmitted by a payment network, and to a computer readable medium containing program instructions for executing a method for uniquely identifying a merchant from a transaction string transmitted by a payment network.

The computer implemented system, method and medium described herein can provide a number of advantages, such as uniquely identifying each merchant in a transaction with a merchant ID to enable linking and correlating of additional data on the merchant. The additional data may include, for example, data from third party sources such as Dun & Bradstreet or InfoGroup. The system and method may also involve linking and compiling data on corporate affiliates of the merchant, which can enable greater insight into the corporate family of the merchant. Additional advantages include enabling data analytics on positively identified merchants and merchant locations linked to transactions, targeted marketing to card holders based on location data, and providing improved reporting to card holders using the standard company name and business address rather than an abbreviated version in a transaction string. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates an example of a statement from a known credit card issuer in which the credit card issuer is also the owner of the payment network.

FIGS. 2A and 2B provide a description of principles of the invention according to one example, including assigning an industry standard merchant name, creating a hierarchy of stores, and appending third party merchant data.

FIG. 3 illustrates a process flow diagram for merchant tagging according to an exemplary embodiment of the invention.

FIG. 4A illustrates an example of transaction data that includes a valid city and FIG. 4B illustrates an example of transaction data that includes an invalid city.

FIG. 5 illustrates an example of payment intermediary information that may be removed during a data cleansing process according to an exemplary embodiment of the invention.

FIG. 6 illustrates an example of common names related to company formations that may be removed during a data cleansing process according to an exemplary embodiment of the invention.

FIG. 7 is an example of the attributes of a master lookup table according to an exemplary embodiment of the invention.

FIG. 8 is an example of a match process A for null city transactions according to an exemplary embodiment of the invention.

FIGS. 9A and 9B provide an example of a match process B for valid city transactions according to an exemplary embodiment of the invention.

FIG. 10 is a diagram showing the process flow and an example for normalizing a transaction string and using a matching model according to an exemplary embodiment of the invention.

FIGS. 11A, 11B, and 12 show examples of matching a transaction string with a uniquely identified merchant and additional merchant data according to an exemplary embodiment of the invention.

FIG. 13 illustrates a number of enhancements that can be incorporated into the system to improve the match rate, according to exemplary embodiments of the invention.

FIG. 14 provides an illustration of improved reporting to a card holder's mobile device by uniquely identifying the merchant and physical address according to an embodiment of the invention.

FIG. 15 illustrates an example of attributes that can be utilized in a match process C for travel and specified merchant (e.g., Walmart) transactions.

FIG. 16 is a process flow diagram showing scripts that can be used for data preparation and cleansing, merchant tagging, and combining steps according to an exemplary embodiment of the invention.

FIG. 17 is an example of raw transaction data and a derived data set for various transaction types according to an exemplary embodiment of the invention.

FIG. 18 is a diagram of a computer-implemented system for enrichment of transaction data according to an exemplary embodiment of the invention.

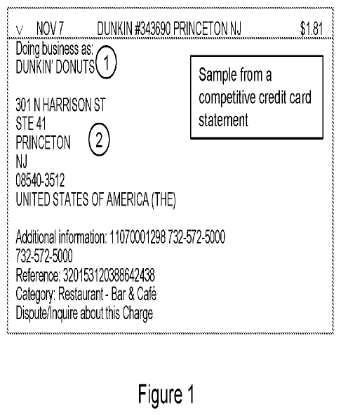

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

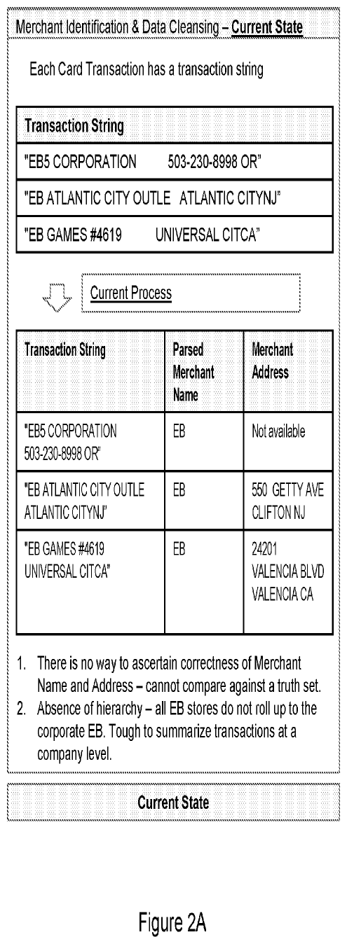

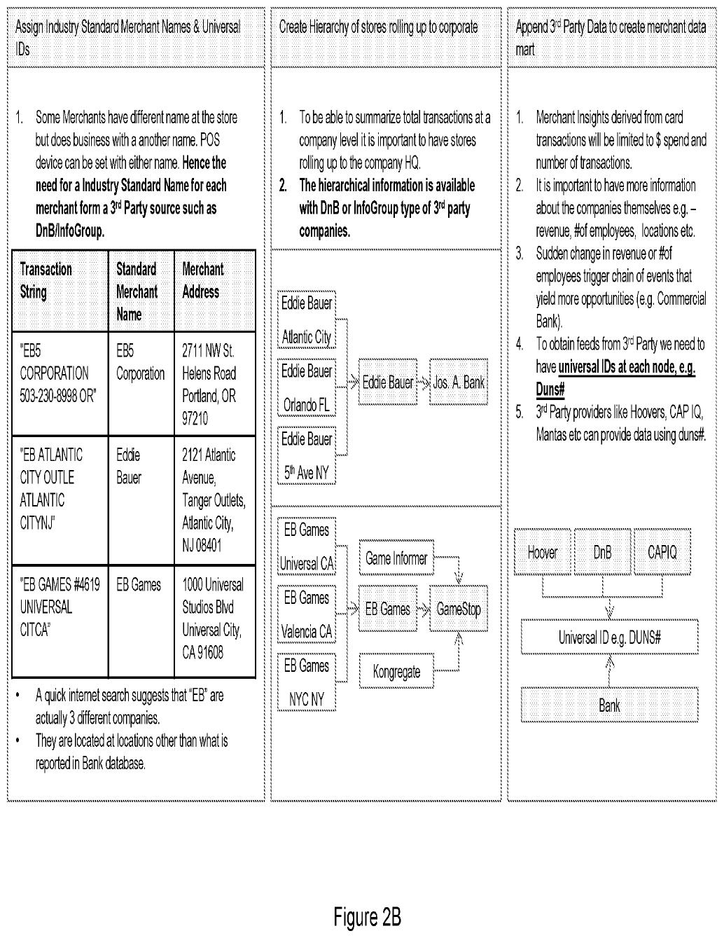

FIGS. 2A and 2B provide an example illustrating the challenges with the limited information in existing transaction strings (FIG. 2A) and the objectives of exemplary embodiments of the invention to address the deficiencies present in the transaction strings (FIG. 2B). FIG. 2A shows an example of the current state in which the parsed merchant name “EB” may appear in multiple transaction strings. From the transaction string, there is no way to ascertain the correctness of the merchant name and address, and there is no information on a corporate hierarchy, thus making it difficult for to summarize transactions at a corporate level.

FIG. 2B illustrates objectives of exemplary embodiments of the present invention including establishing a standard merchant name, attaching an address and geographic location to transactions, creating a merchant hierarchy such that transactions can be rolled up to a corporate level to augment the issuing bank's understanding of customer spend, and appending data concerning the merchant from third party data sources. FIG. 2B also shows that although each of the strings in FIG. 2A has the same parsed merchant name (EB), these strings actually represent three different companies (EB 5 Corporation, Eddie Bauer, and EB Games).

The corporate hierarchical information is available from third party databases such as InfoGroup or other data provider, for example. It can be valuable to an issuing bank or financial institution (sometimes referred to herein as the “Bank”) to have more comprehensive data on an entire corporate family, which is enabled by standardizing the merchant name, associating it with a universal ID (e.g., Duns #), and associating it with its affiliated companies. In addition, once the merchant and corporate family are identified, it is possible to obtain significant additional data on the merchant or company from third party data sources such as Hoovers, DnB, or CAPIQ. Examples of data that may be useful to the Bank include revenues, number of employees, locations, etc. For example, the Bank may monitor and analyze such data to identify other opportunities to provide financial services to the company in question. Once obtained, the standard merchant name, address and geo location, and global parent roll up information can be very useful to different divisions of a Bank. For example, it can be used to support various data analytics functions, marketing and promotion of products and services, risk analysis, fraud analysis, and enhancement of payment systems for the financial institution and its customers.

According to one embodiment of the invention, a system and method are provided to cleanse, standardize and enrich the transaction string that may originate from a point of sale (POS) device to improve contextual information of the transaction. A purchase made by a customer using a credit card or debit card is captured and entered into a POS system. The transaction is then processed through a physical or virtual terminal at the merchant. This terminal feeds information associated with the transaction to the card association networks (e.g., MasterCard or Visa) for authorization. The merchant information acquired in this process is a free flow text manually entered for each POS system and hence varies highly across the same merchant, making it difficult to recognize merchants for each transaction.

According to exemplary embodiments of the invention, the merchant tagging process utilizes a combination of comparative string metrics as inputs to a multi-path matching process. A data set from a third party data provider such as Infogroup can be licensed for use as the “truth set” for the string matches. Data providers such as Infogroup can provide an extensive directory or electronic “yellow pages” for companies, including attributes pertaining to location, merchant category and contact information. Based on the string matches, each path of the matching process can be executed.

If the transaction city is populated correctly and can be matched against data from the data provider (e.g., Infogroup), a logistic regression model can be used to score the match probability and assign the best matched tag from the data provider data. If the transaction city is missing, a waterfall approach can be used based on the comparative string metrics to determine the best matched tag from data provider data. For certain specific travel-related merchant category codes (MCCs) and for transactions at the largest merchants (e.g., Walmart), an override process can be used to assign the merchant tag since there is a one-to-one relationship with such merchants. For example, airline and hotel merchants are assigned a unique MCC by the payment networks. And according to an exemplary embodiment of the invention, regular expression rules are used for the largest merchants to ensure completeness and accuracy for these merchants. This provides an additional match step. The combination of all of these processes is a resultant master lookup table that is used to tag transactions. An overarching goal of the merchant tagging process is to provide standardized merchant tags against card transactions that enter the POS stream to inform insights and targeting for data science and merchant analytics.

According to an exemplary embodiment of the invention, there are two core operational processes that are executed. The first process is the “merchant tagging” process to populate a master lookup table. The second process is the “transaction tagging” process to tag each transaction based on the master lookup table created in the merchant tagging process.

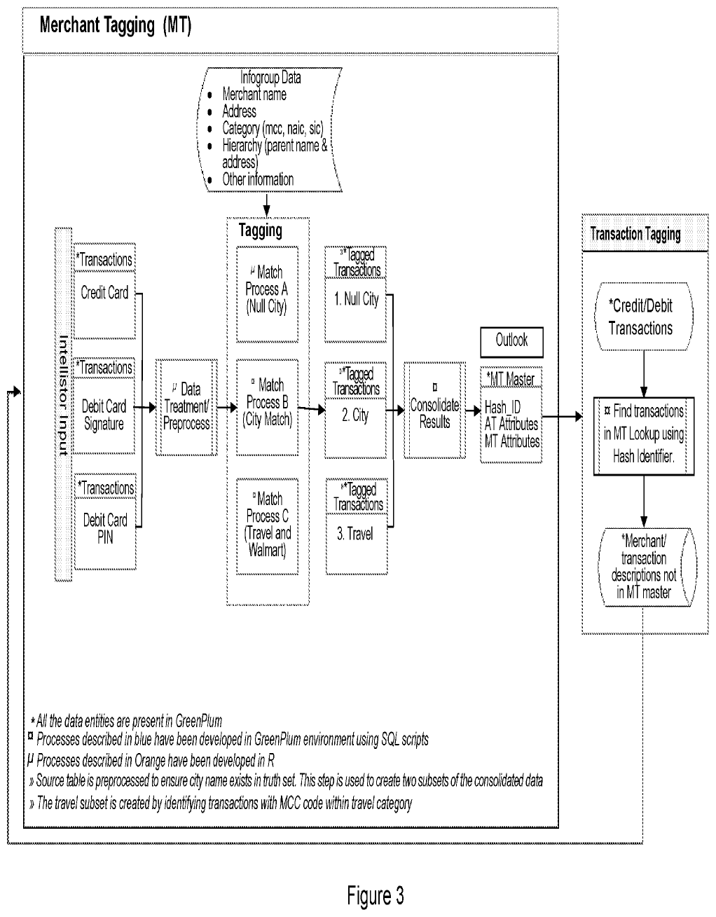

FIG. 3 is a process flow diagram that provides an overview of the merchant tagging process according to an exemplary embodiment of the invention. The merchant tagging process shown in FIG. 3 has the following sub-processes according to an exemplary embodiment of the invention: (1) gathering of inputs, including transaction data and a truth set from the data provider (e.g., Infogroup); (2) treatment of data, including cleansing and preparing data for the match process; (3) the match process, which involves finding the best merchant match for a transaction description using a multi-path matching process including a logistic regression model for “city present” transactions, a waterfall process for “city not present” transactions, and an override for special MCC codes and specified merchants (e.g., Walmart); and (4) consolidation, in which results are retrieved from each match process and consolidated to create/add to a master lookup table.

The merchant tagging process can be run periodically to create and/or update a master lookup table that has attributes from transaction data mapped to matching merchant attributes from the third party data provider data (e.g., Infogroup data). According to one example, the merchant tagging process can be run on a daily basis, or other period, based on the run times and data validations to be performed on the results.

When a new transaction dataset is received, there is a transaction tagging process according to an exemplary embodiment of the invention. During the transaction tagging process, the transaction is tagged by matching against the master lookup table using a hash identifier created at the transaction level to match against a hash identifier in the master lookup table. The hash identifier can be generated using the following attributes from the transaction data according to an exemplary embodiment of the invention: (1) at_merchantid; (2) at_transactiondescription; (3) at_stateprovince; (4) at_city; (5) at_postalcodel; and (6) at_mcccode. Transactions that are successfully matched are ready for downstream usage such as data science work, analytics or in end user applications. Transactions that cannot be matched become inputs for future runs of the merchant tagging process to augment the master lookup table, according to an exemplary embodiment.

The merchant tagging process requires two primary data sets as input: transaction data and a truth set. Transaction data can be obtained from an internal source such as an integrated consumer data warehouse (ICDW) or another source such as an external payment network source. The transaction data can be stored in a normalized database of the Bank. In the example in FIG. 3, this database is a GreenPlum database named “Intellistor.” A mapping can be defined between the ICDW source tables to the Intellistor tables, e.g., for credit card transactions, debit card with signature transactions, and debit card with PIN transactions.

Data sets can be created that aggregate transaction records by unique transaction description, merchant ID, merchant city, merchant state, merchant zip, and merchant category code. This type of aggregation can enable prioritization of modeling efforts on the strings in order of descending transaction volumes and dollars, for example. In addition, a mapping of source transaction merchant category code (MCC) to the corresponding North American Industry Classification System (NAICS) code that may be used by the third party data provider can be developed and used to compare the merchant's industry classification. The business data provided or licensed by the third party data provider can be used as the comparative truth set. For example, a “full business” table and “preverified” table can be obtained from third party data provider, Infogroup. In this example, the full business table is a list of all businesses that Infogroup is aware of in the United States, and the pre-verified table is a subset that includes the businesses that Infogroup associates have called to confirm.

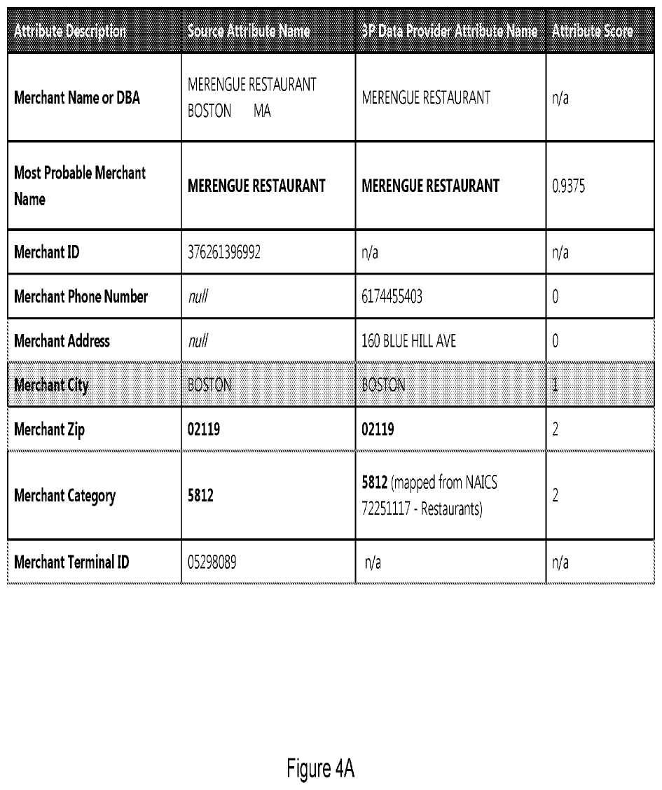

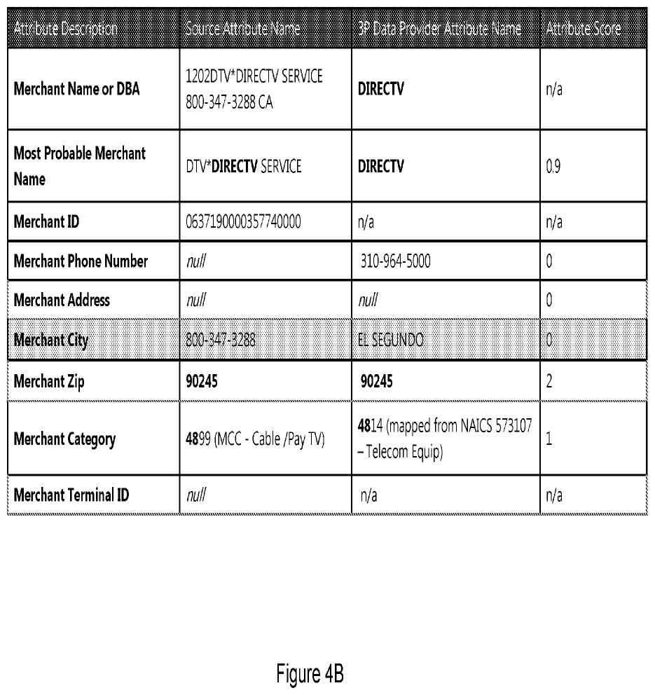

The data treatment process will now be described according to one embodiment of the invention. In order to facilitate matching to the truth set, the transaction descriptions containing merchant name are run through an iterative process to achieve a cleansed string, which may be referred to as the “most probable merchant name.” The three types of transaction inputs (e.g., credit, debit with PIN, debit with signature) are treated to cleanse the city data from the transactions. This process includes the following steps according to one embodiment of the invention: (1) unique city and state records are extracted from the transaction data; (2) a similar set of city and state records are created using third party data provider data; (3) a loop is executed to go through each state, that identifies the best data provider city match for transaction cities using a string distance method; (4) a score is created for each match found in the above step; (5) records with a match score greater than 0.9 are retained and all other transaction cities are tagged “not applicable” or “N/A” to discard invalid city data; and (6) a lookup table is created that consists of city and state attributes from both transaction data and third party data provider data. FIG. 4A provides an example of a table of transaction data for a transaction with a valid city. FIG. 4B provides an example of a table of transaction data for a transaction with an invalid city (in which the city looks like a phone number).

According to an exemplary embodiment of the invention, the three transaction inputs (credit, debit with PIN, and debit with signature) are consolidated and the city cleansing step in the data treatment process is used to create two subsets of the consolidated data. A third subset can be created by identifying transactions with MCC codes within certain travel categories (e.g., airline, hotel, car rental). Only the subsets (a) and (b) as follows are mutually exclusive according to one embodiment: (a) transactions with a valid city value; (b) transactions with no city or invalid city; and (c) travel and specified merchant (e.g., Walmart) transactions.

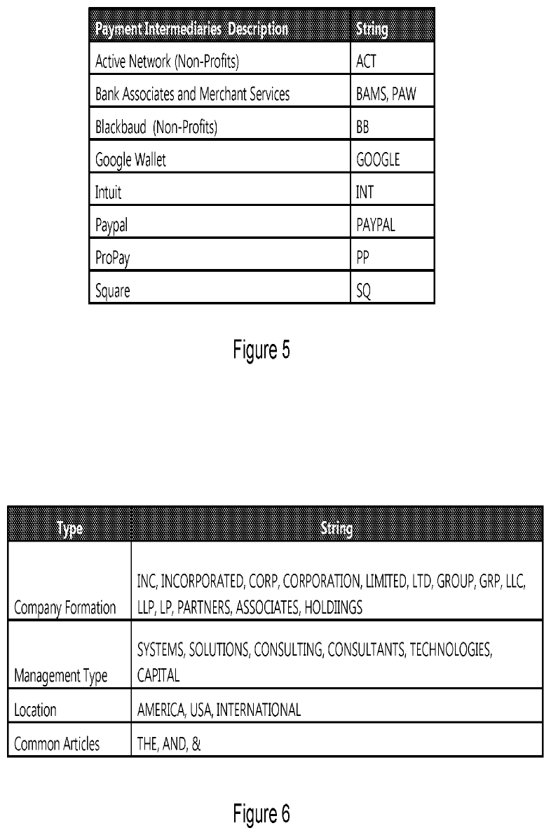

Further cleansing can be performed in each of the match processes. Cleaning steps may include (1) removal of payment intermediaries identified by “__*_”, (2) removal of common names related to company formations using regular expression, and (3) parsing of location attributes such as city and state. An example of a payment intermediary identified by “__*_” is “SQ*” for Square payments. Additional examples of payment intermediaries and their associated strings are shown in FIG. 5. Examples of common names related to company formations are shown in FIG. 6. Parsing of location attributes such as city and state may involve, as one example, starting with a raw transaction description, e.g.: “MERENGUE RESTAURANT BOSTON M” and parsing out the location attributes “BOSTON M” to obtain the most probably merchant name: “MERENGUE RESTAURANT.”

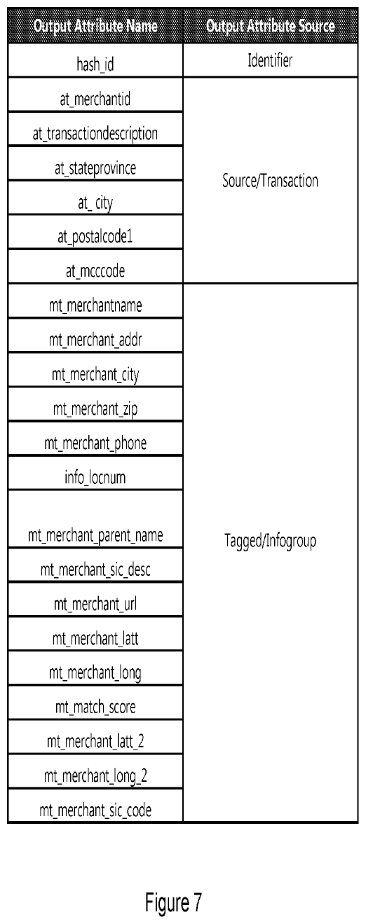

Referring again to FIG. 3, after the match processes have been executed, the results from each of the match processes can be combined and a hash identifier can be generated. This combined output can be used to create a master merchant-transaction look up table. The combined output from any successive execution of merchant tagging is added to the lookup table to maintain one master merchant tagging data set. The final output contains for each transaction the source attributes and third party data provider (e.g., Infogroup) attributes from the tagging process. A database table is created with transactions from each tagging process. The master lookup table has the attributes shown in FIG. 7 according to one embodiment of the invention.

An example of the match process methodology will now be described. The foundation of the match process can be based on comparative string distances according to one embodiment of the invention. The Bank match process may use the industry standard Jaccard and Jaro Winkler string distance metrics to compute a “similarity” metric between two strings (e.g., input vs. truth set). Three datasets created after the data treatment process follow different merchant tagging processes. The following description explains in detail the methods used for each of the subsets according to an exemplary embodiment of the invention.

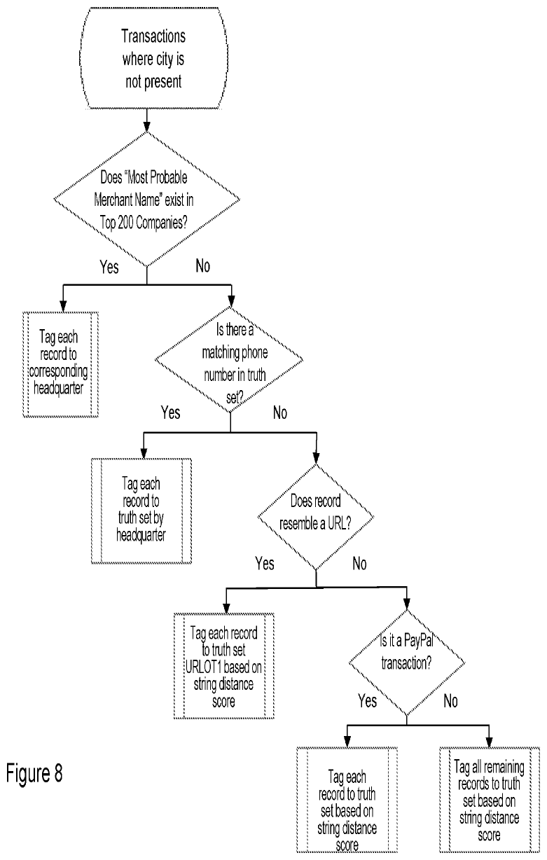

For null city (city not present) transactions (referred to as “match process A”), a waterfall approach can be used to match each transaction within this subset. FIG. 8 is a flow chart depicting the waterfall approach. As shown in FIG. 8, the top merchants can be identified based on transaction count rank. The transaction counts can be detected through unique regular expressions. These transactions can be tagged to their corresponding headquarter location in the truth set.

If the most probable merchant name does not exist in the top 200 companies (or other desired number), the phone number of records not matched in the above set can be used to match against the phone number in the truth set.

The transaction description of the transactions not tagged as described above can be assessed to identify if it contains a URL (e.g., WWW, .com, .org, .gov, .edu). These transactions can be matched to URL's in the truth set and tagged using the string distance method.

If there is no URL match, a PayPal identification logic can be used to check if remaining transactions are PayPal transactions. These transactions can be tagged using the string distance method.

All remaining transactions can be matched to company name in the truth set and tagged using the standard string distance methods.

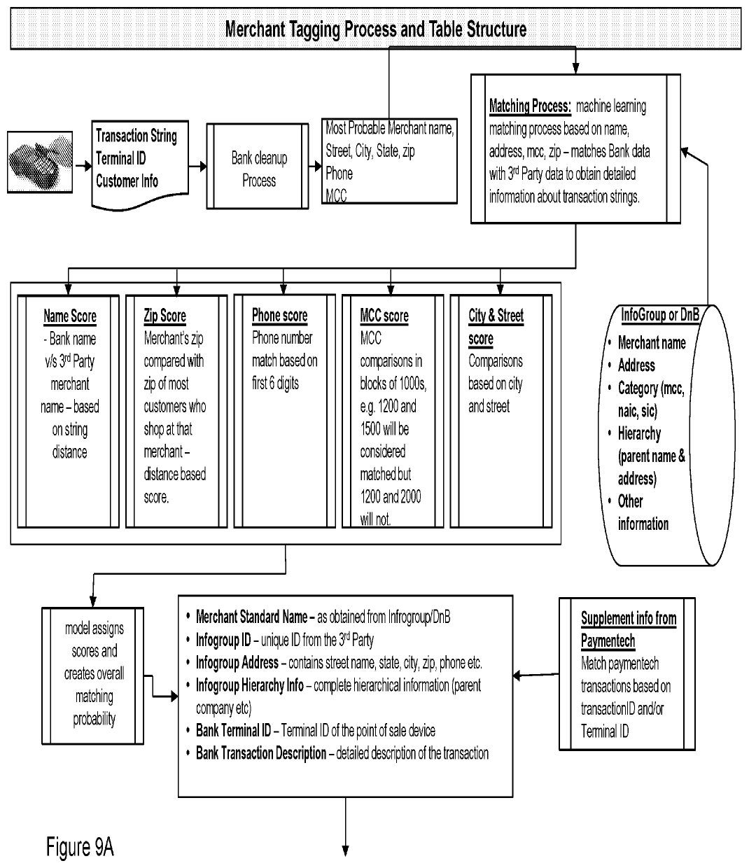

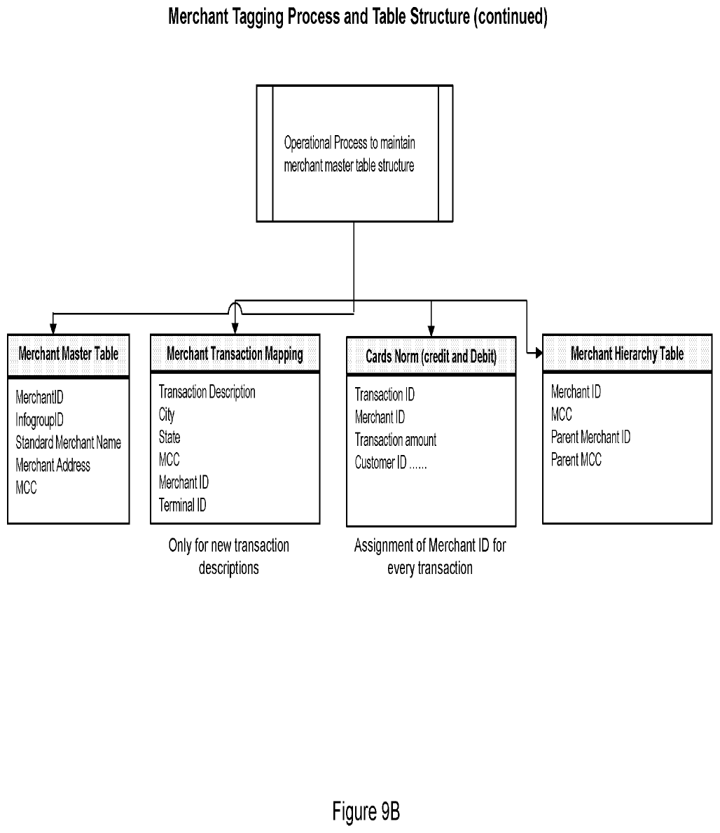

Referring to FIGS. 9A and 9B, for city transactions (referred to as “match process B”), this process utilizes a logistic regression model that produces a composite score that regresses cleansed data attributes from a transaction string across merchant attributes sourced from a third party data provider (e.g., Infogroup). FIGS. 9A and 9B describe the tagging process steps and structure. The process creates two Cartesian sets for the model scoring based on the transaction attributes and string distances to create a match score and probability score. The following steps are conducted in match process B according to one embodiment of the invention.

1. A subset with transactions with valid city data and another with third party data provider data are created.

2. The MCC code is added to the third party data provider data using an MCC-Locnum match in the MCC lookup table.

3. Two separate letter pair data sets are created, one each for transaction data and third party data set data.

4. The above data sets are joined on zip code to create a Cartesian product set.

5. The records from the data set in step 4 are assigned a match score using the string distance method for each of the following attributes: company name, parent company, zip code, MCC, phone number, and address.

6. The match scores from step 5 above are input to the logistic regression model to generate rank and probability.

7. Records with rank=1 and probability >70% are tagged as matches.

8. Matches with rank=1 and probability <70% are then used to create another Cartesian product by joining transaction data and third party data provider data on the city.

9. Steps 5 and 6 are repeated for city Cartesian product.

10. Records with rank=1 are tagged as matches.

FIG. 9B illustrates the table structure for storage of the merchant data and related data according to an exemplary embodiment of the invention. According to this example, the system includes a merchant table, a merchant transaction mapping table, a cards norm table, and a merchant hierarchy table. FIG. 9A also illustrates that the compilation of data on the merchant can also include obtaining supplementary information from a payment processor (Paymentech in the FIG. 9A example).

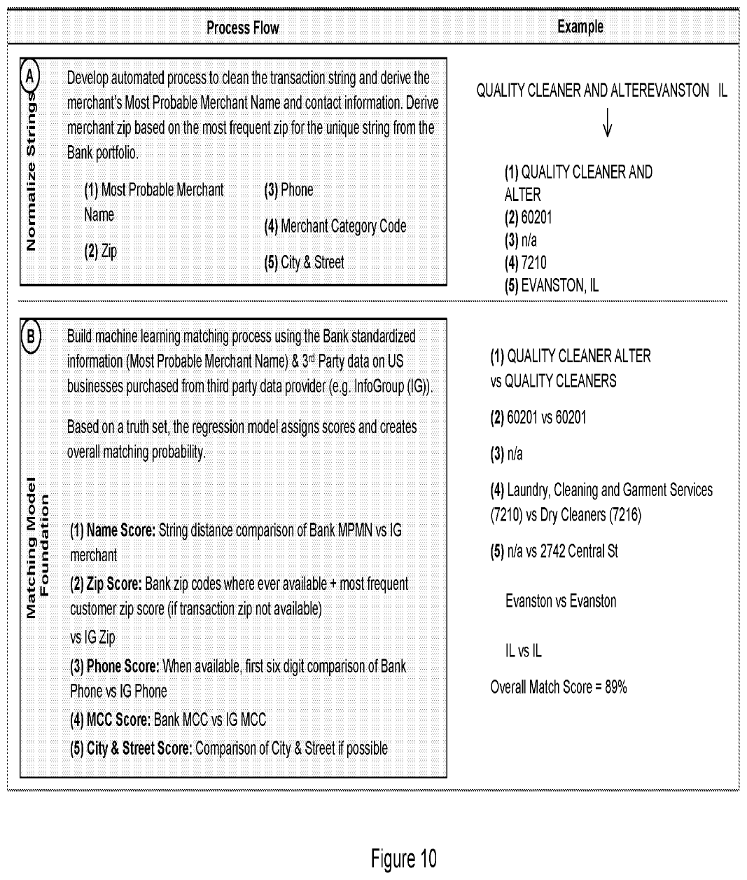

FIG. 10 illustrates one example of the process for cleaning the transaction string and deriving the merchant's most probable merchant name (MPMN) and contact information. The merchant's zip code can be derived based on the most frequent customer zip code used in transactions identified by the particular transaction string in question. A machine learning matching process can then be used in connection with standardized information of the financial institution (e.g., MPMN) and additional merchant data acquired from a third party data provider. Based on a truth set, the regression model assigns scores and creates an overall matching probability. The example in FIG. 10 shows five elements that are compared between the data set of the financial institution (JPMorgan Intelligent Solutions in this example) and the data set of the third party data provider (InfoGroup in this example). The regression model assigns scores based on the similarity between each element, including a name score, zip code score, phone score, Merchant Category Code (MCC) score, and city & street score. The regression model then calculates an overall match score (89% in the FIG. 10 example) based on the collective proximity. The overall match score provides a probability that the merchant information identified by the financial institution matches a particular merchant and physical location provided by the third party data provider.

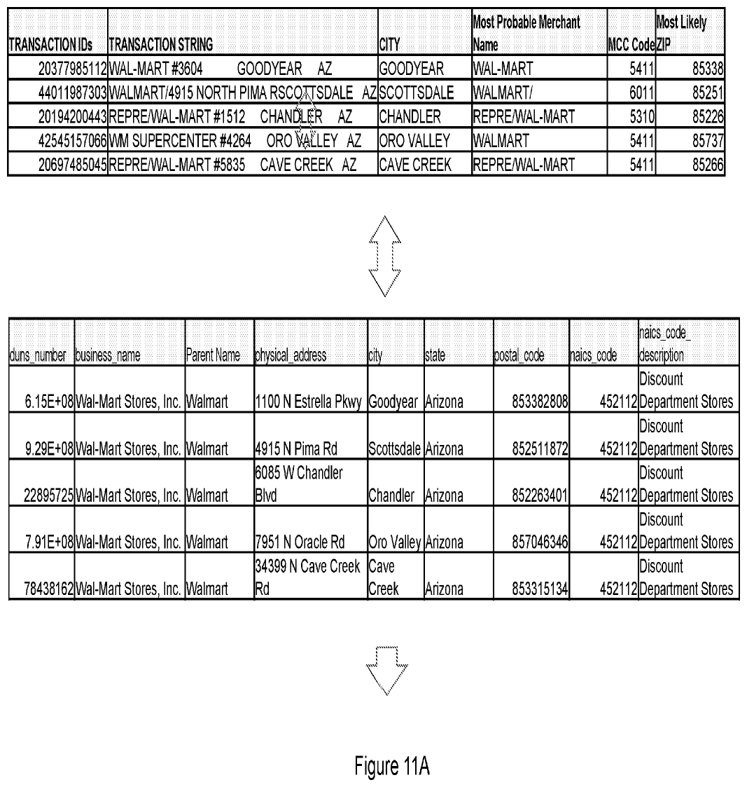

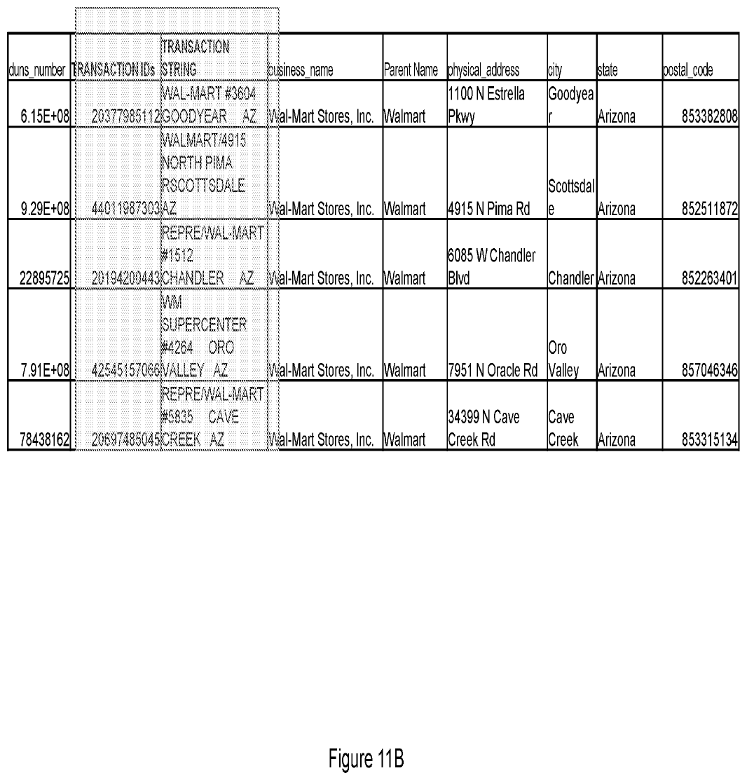

FIGS. 11A and 11B illustrate an example of the results of the process for matching the merchant information in the transaction string to the more comprehensive merchant data compiled from third party and internal sources to produce a much more useful result. FIG. 11A provides examples of transaction strings and transaction IDs that have been processed by the financial institution to determine a most probable merchant name and most likely zip code. This process is illustrated in FIG. 10, block A. These records are then input to the machine learning matching process (FIG. 10 block B) along with third party (e.g., InfoGroup) information on the merchants. The result, shown in FIG. 11B, is a matching of the transaction ID and transaction string with the duns number for the merchant, standardized merchant name, name of the parent company, physical address, city, state, and zip code of the merchant.

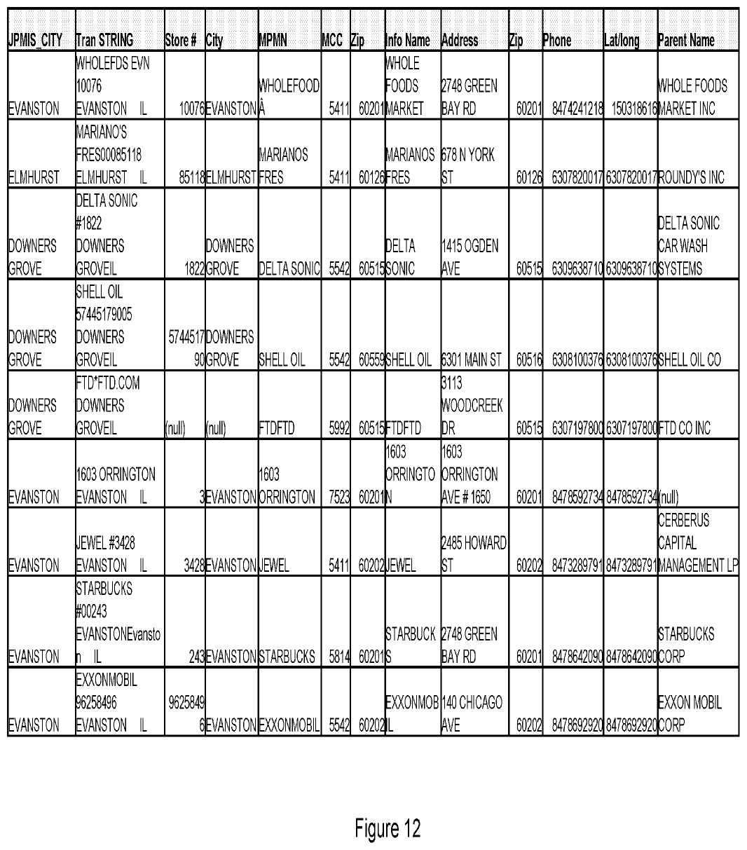

FIG. 12 provides additional examples of the matching results, which also include a phone number, store number, and geo location (e.g., latitude and longitude) for each merchant. The ability to uniquely identify the merchant from the transaction string and other data using the machine learning matching process provides a number of advantages. For example, it enables the financial institution to compile and analyze transaction data at each merchant location. It also allows the financial institution to associate that data with a wealth of other data on the merchant and its affiliated companies. It also allows the financial institution to provide more customized information and offers to its cardholders.

According to one embodiment, the matching algorithm for computing a score using a string distance method calculates a probability of matching a merchant based on distances calculated with respect to zip score, MCC score, name score, phone score, and address score. The name score is the string distance between the transaction merchant name and the third party data provider (e.g., Infogroup (IG)) merchant name. The zip score is the geographical distance between the transaction zip code and the third party data. The phone score is a numerical similarity computed by an area match followed by a last 4 digits match of phone numbers. The MCC score is a numerical score computed by comparing merchant category code numbers within a series. The address score is a string distance between the transaction address and the merchant address provided by the third party data source.

According to one example, to pick the best match from scores, the scores are computed using a string distance method. Several distance measures can be used and the one that gives the best reading can be selected for the model. According to one example equation, the probably of match=−6.8948+coalesce(match_zip_score,0)*0.2267+coalesce(match_mcc_score,0)*0.8164+coalesce(match_name_score,0)*9.3429+0.33*coalesce(match_phone_score,0)+3*coalesce(match_address_score,0)+4*coalesce(match_parent_score,0).

The name score=string distance between transaction merchant name and third party data provider merchant name. The zip score=geo distance between transaction zip code and third party data. The phone score=similarity computed by area match followed by last 4 digits match of phone numbers. The MCC score=similarity computed by comparing within series. The address score=string distance (same as name score).

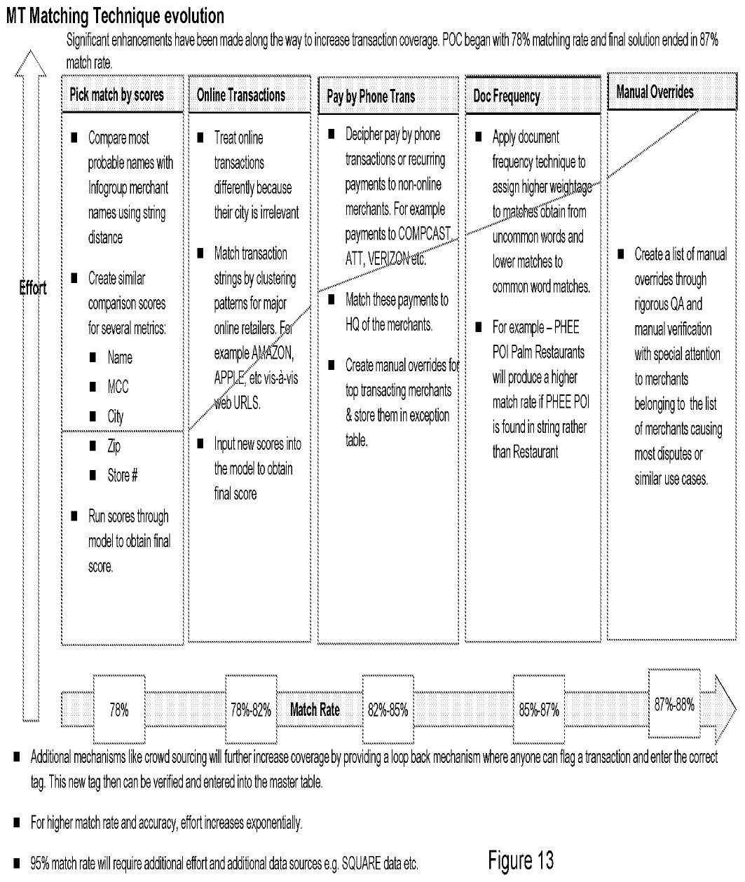

FIG. 13 illustrates a number of enhancements to the matching process that can be implemented to improve the probability of correct matching results according to exemplary embodiments of the invention. In FIG. 13, the column entitled “Pick match by scores” represents the process described above in which an overall matching probability is calculated based on individual string distance scores. The column entitled “Online Transactions” describes an enhancement involving a modified analysis and treatment of online transactions because the physical location is irrelevant. This enhancement entails matching transaction strings by clustering patterns for major online retailers such as Amazon and Apple vis-à-vis web URLs. The column entitled “Pay by Phone Trans” describes an enhancement that entails the matching of pay-by-phone transactions or recurring payments to non-online merchants, such as Comcast, AT&T, and Verizon. These transactions can be matched to the headquarters of the merchant. In addition, manual overrides can be created for top transacting merchants and they can be stored in an exception table. The column entitled “Doc Frequency” describes an enhancement that entails applying a document frequency technique to assign a higher weight to matches obtained from uncommon words and a lower weight to uncommon word matches. The column entitled “Manual Overrides” describes an enhancement that entails creating a list of manual overrides through rigorous quality assurance (QA) and manual verification with special attention given to merchants belonging to a list of merchants causing most disputes or similar use cases. As shown in FIG. 13, these enhancements can provide a significant increase in the match rate, e.g., from 78% to 87-88% according to one embodiment of the invention.

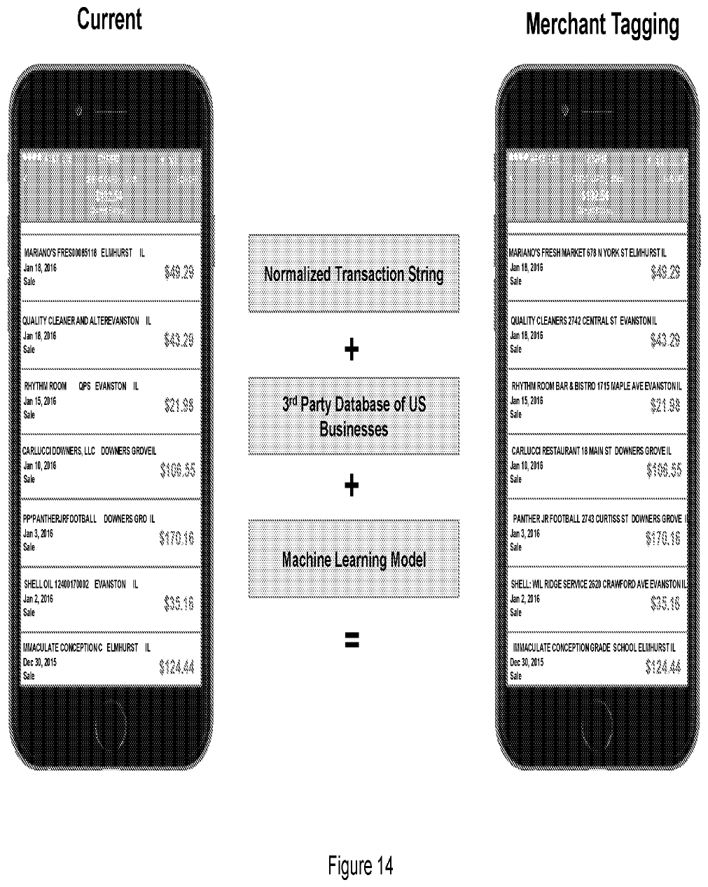

FIG. 14 provides an illustration of one advantage provided by exemplary embodiments of the invention with respect to the card holder. As shown in FIG. 14, the credit card issuer is able to provide the card holder a much clearer identification of the merchant in each transaction as a result of the normalized transaction string, the third party database of merchants, and the machine learning model. This presentation reflects well on the credit card issuer because it may have the effect of demonstrating that the credit card issuer is aware of exactly which merchant conducted the transaction, in contrast to the transaction strings that are difficult to understand.

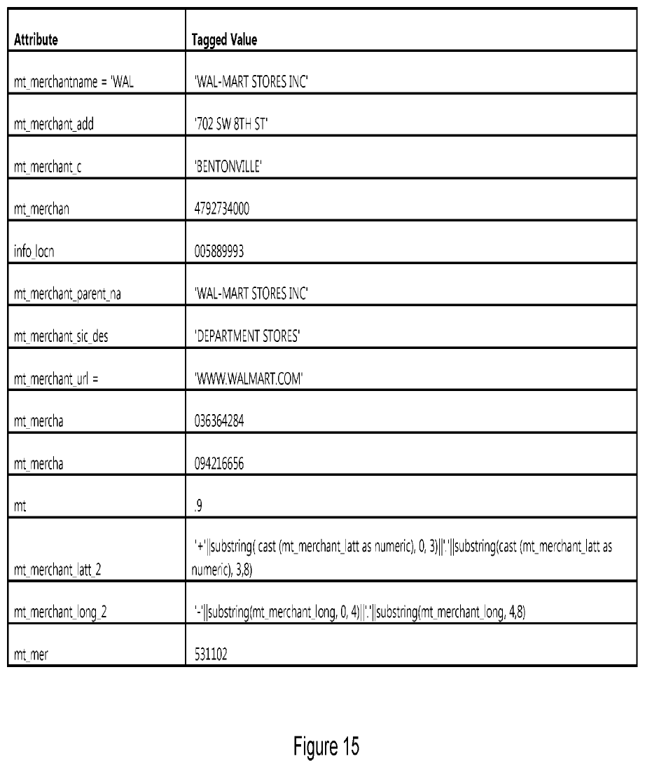

Referring again to FIG. 3, for travel related transactions (e.g., identified by certain MCCs) and transactions involving a specified merchant (e.g., Walmart) (referred to as “match process C”), the result sets from the above two match processes are combined for the final match process according to an exemplary embodiment of the invention. In this example, Walmart supercenter transactions are identified by searching for transaction descriptions that contain the pattern: ‘%wm%supercenter%’. A large population of records may be found to have the above pattern. Any record that has already been identified as having Walmart as merchant name is excluded from this step. FIG. 15 illustrates an example of values that are tagged for the foregoing transactions involving a specified merchant such as Walmart.

An override can be applied to JetBlue transactions according to one embodiment of the invention. These transactions are identified using MCC code 3174. Hotel transactions are identified using MCC code between the range 3500 and 3800. A string distance score is created for hotel transactions that have already been matched. Records with a score <0.1 or unmatched transactions are then assigned tagging using the MCC code. The reassignment of merchant tagging is performed as the city match process identifies hotels and location. Airline transactions are identified using MCC code between the range 3000 and 3299. Transactions that have already been identified as airline are excluded from this step. Car rental transactions are identified using MCC code 3405, 3357, 3393, 3395, 3387, 3366, and 3390. The additional steps described above for hotel transactions are also carried out for airline transactions and car rental transactions.

Implementation of the merchant tagging process can involve multiple components both internal and external to the Bank environment, according to one embodiment of the invention. The software code that executes the merchant tagging process may be developed by creating R and SQL scripts, for example. The software used for creating R scripts may be RStudio and for SQL scripts may be PGAdmin according to one example. The merchant tagging process may be executed as a batch process according to one embodiment.

The merchant tagging system and method may include a data validation process. The data validation process may capture the following metrics on a period over period basis, according to one embodiment: (1) transaction coverage, including the number of tagged transactions, the total number of transactions excluding payments and fees, and the number of tagged transactions as a percentage of the total number of transactions; (2) transaction coverage per customer, including the number of tagged transactions per customer, the total number of transactions per customer excluding payments and fees, and the number of tagged transactions as a percentage of the total number of transactions per customer; (3) new merchant transactions, including the number of transactions from new merchant transactions (transactions that do not match to a record in merchant tagging master lookup), the number of transactions from this pool of transactions that gets tagged by the merchant tagging process, the number of transactions from this pool of transactions that remain untagged post matching process, and the ratio of untagged vs. tagged transactions from this pool of new merchant transactions after matching is completed. This will indicate the yield of the matching process over time and indicate if the algorithms or the truth set needs to be updated; and (4) merchant tagging accuracy. Additional tests may be being designed and implemented to provide an accurate measure of the merchant tagging process.

The various components of the merchant tagging process described above can be executed using SQL and R scripts, according to one embodiment of the invention. A merchant master lookup table can be created to store the matches generated from previous transaction tagging. On receiving a new transaction file, a hash identifier may be created for each transaction. This hash identifier is used to locate if the transaction has already been identified and exists in the merchant tagging master lookup table. Transactions that do not have a corresponding hash identifier in the master lookup table are fed back into the merchant tagging process.

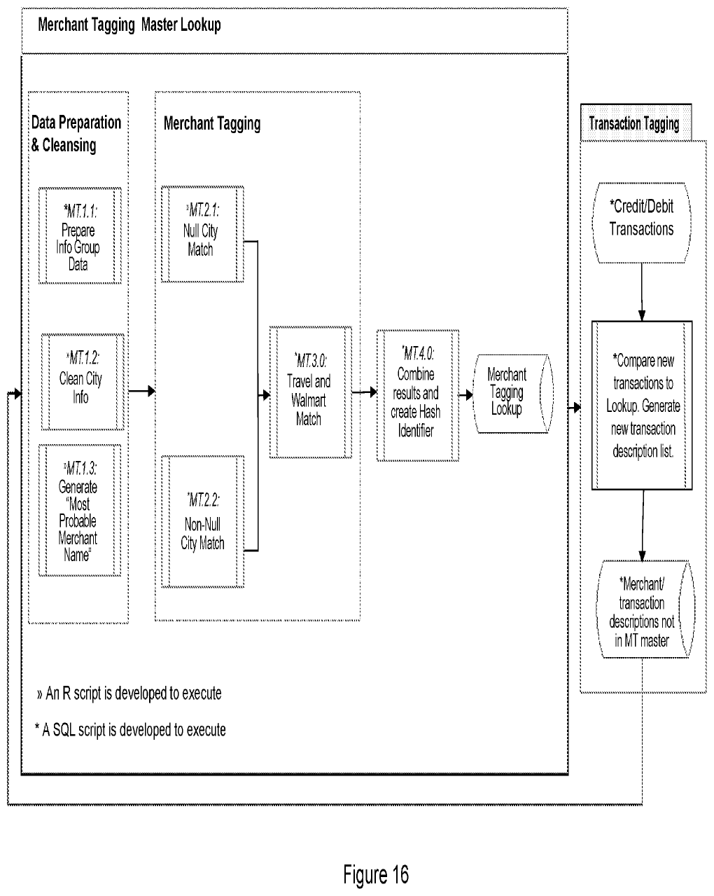

FIG. 16 depicts the sequence of scripts executed for merchant tagging on receiving credit card, debit card PIN, and debit card signature transactions. As shown in FIG. 16, MT.1.1 represents an SQL script that prepares data from the third party data provider (e.g., Infogroup) to be used as a truth set for the tagging process. This step creates a list of parent companies, generates a data set for all records in the data provider data set, and adds the parent company name to the data set.

MT.1.2 depicts an R script that may be developed to create cleansed city data sets using the data treatment process described above.

MT.1.3 represents a script used to generate a “most probable merchant name.” An R code is created to run a series of regular expressions that generates patterns of text within a transaction description that should not be a part of merchant name. This code then generates an attribute DIS_Merchant which is used to match to company name in data provider data during the matching processes.

MT.2.1 represents a script that executes the match process for null city transactions. The script may be developed in R to execute the series of steps explained above for match process A (null city transactions).

MT.2.2 represents a script that executes the match process for non-null city transactions (match process B described above). The script may be developed in SQL and run on PGAdmin.

MT.3.0 represents a script that executes the match process for travel and Walmart transactions (match process C described above). The script may be developed in SQL and run on PGAdmin.

MT.4.0 represents a script that consolidates the outputs from step MT.2.1, MT.2.2, and MT.3.0 and generates a merchant tagging master lookup. The master lookup table may have the attributes shown in FIG. 7.

According to other embodiments of the invention, the merchant tagging process may be enhanced to provide additional advantages. For example, a merchant services provider (e.g., Paymentech) can provide the Bank with merchant acquiring data for merchants that use that merchant services provider. By linking the acquiring transaction data with issuing side transaction data, the Bank can assign the merchants that use the merchant services provider to the issuing side transaction data. This will generally be more accurate since the acquiring side merchant information is exact information.

As another example, the truth set can be enhanced. For example, the Bank may obtain additional third party data sets (e.g., store location data and/or small and medium enterprise datasets) to match additional source attributes. The store location data may comprise “aggdata,” for example, that provides multiple data sets containing store information (store number, location details) for US businesses. https://www.aggdata.com/. This data set can be used to match transactions to individual store locations for greater match accuracy. With respect to a small and medium enterprise dataset, an additional match process may be created to identify small business and local stores there by increasing coverage of the merchant tagging process. As one example, the following data set contains over 49 million US businesses: http://www.usbizdata.com/us-business-database.php.

According to another embodiment of the invention, a system and method for transaction data enrichment (TDE) can be provided to enrich transaction data associated with automated clearinghouse (ACH) transactions, wire transactions, and bill pay transactions.

The first part of the process involves extracting matching criteria. Scripts can be used to extract pertinent identifiers from the raw transactions in the systems of record, e.g., for ACH, wire, and bill pay transactions. The originator/counterparty string is extracted and a most probable business name is generated. Transaction identifiers are cleansed to create normalized strings that can be uniformly cross-examined with a third party truth set. According to one example, the transaction elements from ACH, wire and bill pay transactions are matched to verified truth sets from third party data providers such as Infogroup, InsideView, D&B, and CapIQ using a customized string-distance machine learning algorithm. The merchant/originator/counterparty is assigned an identity based on the best fit according to the algorithm.

The merchant/originator/counterparty is assigned an identity based on the best fit according to the algorithm. The string distance metrics utilized to match against the third party truth set are the following according to one embodiment of the invention.

Jaccard Distance: given two strings, break each string into distinct 2-letterpairs. Then divide the intersection of 2-letterpairs by the union of 2-letterpairs. The complexity is linear. (O(|s1|+|s2|)).

Jaro Distance: given two strings, search for common characters (matching characters range <=(max(|x|,|y|)/2)−1), and transpositions (number of matching characters divided by 2). This process is typically well suited for comparing smaller strings, such as words and names. The time complexity is linear (O(|s1|+|s2|).

Jaro-Winkler Distance: given a precomputed Jaro metric, add a constant that emphasizes the number of characters that match in the first four positions of each string. The time complexity is the same as Jaro.

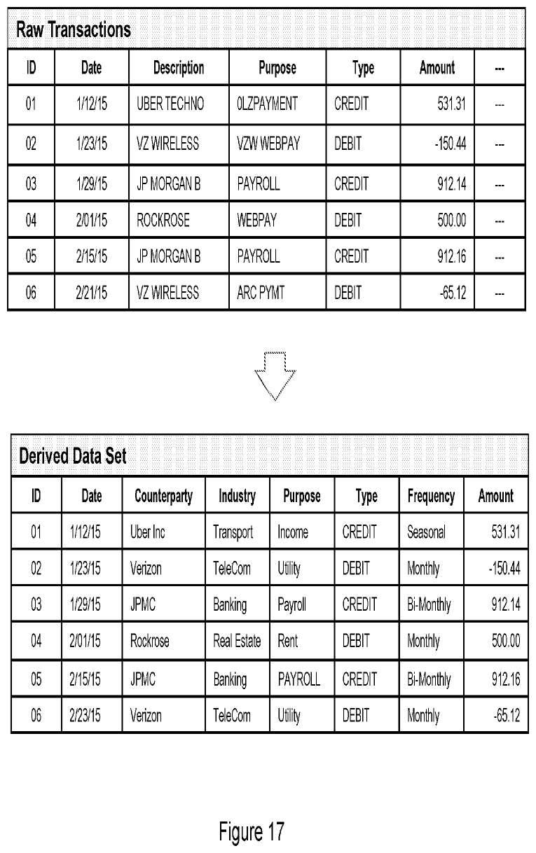

An example of raw transaction data and a derived data set is set forth in FIG. 17. As can be seen in FIG. 17, the raw transaction data includes a Description and Purpose that may be relatively difficult to understand. The derived data set, on the other hand, provides a unique description of the counterparty as well as clear descriptions of the industry, purpose, type of transaction, frequency and amount. This derived data can thus be used for improved analytics conducted by the Bank.

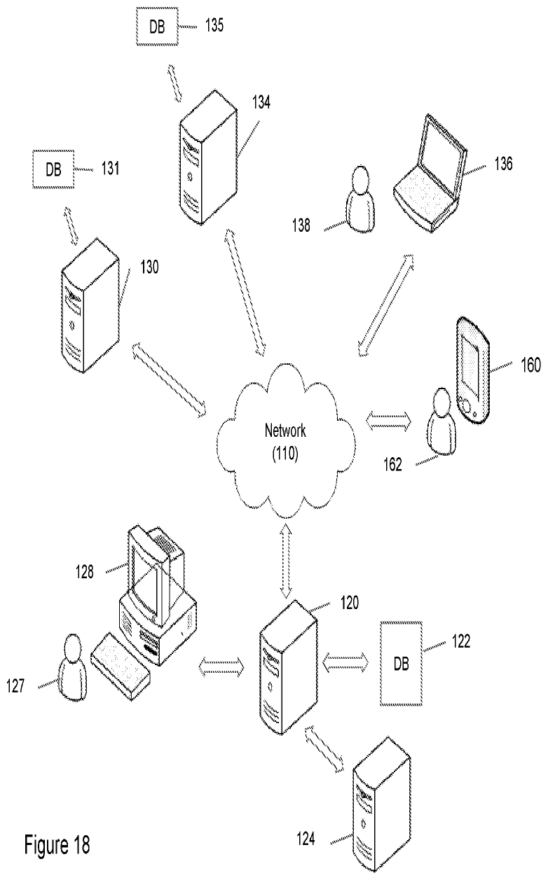

FIG. 18 is a diagram of a system for enrichment of transaction data according to an exemplary embodiment of the invention. As shown in FIG. 18, the system may include a network and one or more computing devices, such as servers, desktop computers, laptop computers, tablet computers, and other mobile computing devices. The system may be operated by an issuer of credit cards and/or debit cards, for example, or other entity that processes financial transaction data or provides financial services, such as ACH, wire, and/or online bill pay services. For simplicity, the example set forth below will be described in terms of a system operated by an issuing bank. However, those skilled in the art will appreciate that other types of companies, such as companies processing financial information, can operate and maintain the system.

Referring to FIG. 18, the system may be embodied primarily in an application server 120, which may include a database server 122, owned and/or operated by the financial institution that may interface with one or more other servers and entities via one or more networks. For example application server 120 may interface with a server 124 containing additional data maintained by a different division of the financial institution (e.g., a payment processing division or data analytics division). The network 110 shown in FIG. 18 may comprise any one or more of the Internet, an intranet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, or other network, for example. The application server 120 and other servers 122, 124 that are used or operated by the financial institution can facilitate the identification of merchants, originators, and/or counterparties. The application server 120 may be operated by an analyst 127 using a computing device such as a laptop computer 128. The application server 120 accepts and processes the incoming data and the database server 122 stores that data, according to an exemplary embodiment of the invention. The foregoing description is merely one example of a configuration for such systems and functions and is not intended to be limiting.

Also shown in FIG. 18 are a number of other computing devices such as servers that may transmit data in various formats to the application server 120 via the network 110 according to one embodiment of the invention. For example, a payment network such as VISA or MasterCard, an ACH system, or a wire system may operate a transaction server 130 that provides transaction data in the form of transaction strings containing merchant data or other transaction data to the issuing bank or financial institution. The transaction server 130 may be linked to a database 131 that stores the relevant data. In addition, a third party data provider such as InfoGroup or may store extensive merchant data in a database 135 and transmit it to the issuing bank using a server 134. Additional data relating to the identification of merchants, originators, and/or counterparties may be transmitted by a third party computer 136 operated by an analyst 138. FIG. 18 also shows a card holder or account holder 162 who may receive the enhanced information on transactions via his or her mobile device 160, as illustrated in FIG. 14.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

The mobile device 160 depicted in FIG. 18 may comprise a smart phone, such as an Apple iPhone, Samsung Galaxy, or Amazon Fire Phone, or a tablet computer, such as an Apple iPad or Samsung Galaxy Tab, that includes a touch screen or other interactive display. The mobile device 160 preferably includes hardware and software to enable communication with a cellular network, a WiFi network, and a Bluetooth channel. The personal computing devices 128, 136 may comprise a laptop computer or desktop computer, for example.

Data and information maintained by the servers shown by FIG. 18 may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 110 in FIG. 18, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network 110 in FIG. 18 may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 110 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, the communication network 110 may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of a mobile device 160 and personal computing devices 128, 136 are shown in FIG. 18, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile device 160 and personal computing devices 128, 140, 150 may include various connections such as a cell phone connection, WiFi connection, Bluetooth connection, satellite network connection, and/or near field communication (NFC) connection, for example.

As described above, FIG. 18 includes a number of servers 120, 122, 124, 130, 131, 134, 135 and user communication devices 128, 136, 160, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software, firmware, hardware, or a combination of the foregoing.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 18 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the mobile device 160 or personal computing devices 128, 136. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A computer-implemented system for optimal identification of a merchant name and corresponding information from a transaction string using a multi-path merchant matching process, the system comprising:
a database; and
a computer processor that is programmed to:
gather input information, comprising a plurality of transaction strings from a payment network, wherein each transaction string comprises a plurality of transaction attributes corresponding to a most probable merchant name (MPMN) and one or more of a merchant city, merchant state, merchant zip code, merchant street address, merchant phone number, merchant parent company, and a merchant category code (MCC);
parse each of the plurality of transaction strings received from the payment network to derive a transaction dataset comprising of a most probable merchant name, a most likely merchant zip code and one or more transaction attribute values for each of the plurality of transaction strings, wherein the most likely merchant zip code is derived based on a most frequent customer zip code used in transactions identified by the transaction string;
extract, from the transaction dataset, unique merchant city and state attribute values for each transaction string having a city and state attributes and identify, from a truth set comprising third party provided merchant information records for a plurality of merchants, one or more merchant records corresponding to the state attribute value extracted from the transaction string;
assign, based on a comparative string distance with the unique city attribute from the transaction string, a match score to a merchant city attribute associated with each of the one or more merchant records;
process the transaction dataset to create a first data subset consisting of transaction strings with a valid city attribute, and a second data subset consisting of transactions strings without a valid city attribute, wherein a valid city attribute correspond to a match score, with at least one merchant city in the truth set, that is above a predefined threshold;
execute a first merchant matching process, using a logistic regression model, between transaction strings in the first data subset and a plurality of merchant records in the truth set, the merchant matching process comprising assigning a set of individual attribute scores to each of one or more merchant records in the truth set that match the transaction city and state attributes, wherein the attribute scores are based on a comparative string distance to corresponding transaction attributes in the transaction string;
for each transaction string in the first data subset, compute an overall match score with respect to each of the one or more merchant records in the truth set and tag each transaction string with the merchant record corresponding to the highest overall match score, wherein the overall match score with respect to a merchant record is calculated as a function of the set of individual attribute score assigned to the merchant record;
execute a second merchant matching process, using a waterfall approach, between transaction strings in the second data subset and the plurality of merchant records in the truth set, the second merchant matching process comprising identifying a unique information item in the one or more transaction strings of the second data subset, and matching, based on string similarity metric and regular expression rules, the unique information items against the merchant records in the truth set, wherein the one or more unique information items comprises one of a most probable merchant name (MPMN) attributes from a list of selected merchant, a merchant phone number, a uniform resource locator, and a PayPal transaction identifier;
execute an override merchant matching process for transaction strings associated with a uniquely identifiable MCC attribute by overriding a corresponding best matched tag generated for the transaction string by either the first or the second merchant matching process and matching the transaction string with a merchant record from the truth set that corresponds to the uniquely identifiable MCC code;
consolidate results of the first, second and the override merchant matching process to create a master lookup table having transaction attributes from the transaction string dataset mapped to matching merchant attributes from the truth set, wherein a hash identifier is generated for each record in the master lookup table; and
create a hash identifier, based on transaction attributes, for each new transaction string received and tag the transaction string with corresponding merchant information associated with a matching hash identifier in the master lookup table, wherein transactions that are not matched in the master lookup table are parsed and tagged in accordance to the multi-path merchant matching process and added to the master lookup table.

2. The system of claim 1, wherein the computer processor is further programmed to process the one or more transaction strings in the transaction string dataset to remove payment intermediaries, remove words related to company formation, and parse location attributes.

3. The system of claim 1, wherein the computer processor is programmed to execute the waterfall process by determining whether a merchant name from the one or more transaction strings in the transaction string dataset exists in the master lookup table for a set of the largest merchants.

4. The system of claim 3, wherein the computer processor is programmed to execute the waterfall process by examining whether there is a matching phone number or URL in the truth set.

5. The system of claim 1, wherein the computer processor is programmed to execute the logistic regression model by generating a rank and probability that are used to determine whether a merchant in the truth set matches a merchant specified in any of the one or more transactions strings in the transaction string dataset.

6. The system of claim 1, wherein the computer processor is programmed to execute the override process by using merchant category codes to identify merchants in the travel industry.

7. The system of claim 1, wherein the computer processor is programmed to execute the override process by:
generating a table of transaction attributes that are specific to a merchant; and
searching for one or more matching transaction attributes in the one or more transaction strings.

8. A computer-implemented method for optimal identification of a merchant name and corresponding information from a transaction string using a multi-path merchant matching process, the method comprising:
gathering input information, comprising a plurality of transaction strings from a payment network, wherein each transaction string comprises a plurality of transaction attributes corresponding to a most probable merchant name (MPMN) and one or more of a merchant city, merchant state, merchant zip code, merchant street address, merchant phone number, merchant parent company, and a merchant category code (MCC);
parsing each of the plurality of transaction strings received from the payment network to derive a transaction dataset comprising of a most probable merchant name, a most likely merchant zip code and one or more transaction attribute values for each of the plurality of transaction strings, wherein the most likely merchant zip code is derived based on a most frequent customer zip code used in transactions identified by the transaction string;
extracting, from the transaction dataset, unique merchant city and state attribute values for each transaction string having a city and state attributes and identifying, from a truth set comprising third party provided merchant information records for a plurality of merchants, one or more merchant records corresponding to the state attribute value extracted from the transaction string;
assigning, based on a comparative string distance with the unique city attribute from the transaction string, a match score to a merchant city attribute associated with each of the one or more merchant records;
processing the transaction dataset to create a first data subset consisting of transaction strings with a valid city attribute, and a second data subset consisting of transactions strings without a valid city attribute, wherein a valid city attribute correspond to a match score, with at least one merchant city in the truth set, that is above a predefined threshold;
executing a first merchant matching process, using a logistic regression model, between transaction strings in the first data subset and a plurality of merchant records in the truth set, the merchant matching process comprising assigning a set of individual attribute scores to each of one or more merchant records in the truth set that match the transaction city and state attributes, wherein the attribute scores are based on a comparative string distance to one or more corresponding transaction attributes in the transaction string;
for each transaction string in the first data subset, computing an overall match score with respect to each of the one or more merchant records in the truth set and tag each transaction string with the merchant record corresponding to the highest overall match score, wherein the overall match score with respect to a merchant record is calculated as a function of the set of individual attribute score assigned to the merchant record;
executing a second merchant matching process, using a waterfall approach, between transaction strings in the second data subset and the plurality of merchant records in the truth set, the second merchant matching process comprising identifying a unique information item in the one or more transaction strings of the second data subset, and matching, based on string similarity metric and regular expression rules, the unique information items against the merchant records in the truth set, wherein the one or more unique information items comprises one of a most probable merchant name (MPMN) attributes from a list of selected merchant, a merchant phone number, a uniform resource locator, and a PayPal transaction identifier;
executing an override merchant matching process for transaction strings associated with a uniquely identifiable MCC attribute by overriding a corresponding best matched tag generated for the transaction string by either the first or the second merchant matching process and matching the transaction string with a merchant record from the truth set that corresponds to the uniquely identifiable MCC code;
consolidating results of the first, second and the override merchant matching process to create a master lookup table having transaction attributes from the transaction string dataset mapped to matching merchant attributes from the truth set, wherein a hash identifier is generated for each record in the master lookup table; and
creating a hash identifier, based on transaction attributes, for each new transaction string received and tagging the transaction string with corresponding merchant information associated with a matching hash identifier in the master lookup table, wherein transactions that are not matched in the master lookup table are parsed and tagged in accordance to the multi-path merchant matching process and added to the master lookup table.

9. The method of claim 8, further comprising processing the one or more transaction strings in the transaction string dataset to remove payment intermediaries, remove words related to company formation, and parse location attributes.

10. The method of claim 8, wherein the waterfall process comprises determining whether a merchant name from an incoming transaction string exists in the master lookup table for a set of largest merchants.

11. The method of claim 10, wherein the waterfall process comprises examining whether there is a matching phone number or URL in the truth set.

12. The method of claim 8, wherein the logistic regression model generates a rank and probability that are used to determine whether the merchant in the truth set matches a merchant specified in any of the one or more transactions strings in the transaction string dataset.

13. The method of claim 8, wherein the override process comprises using merchant category codes to identify merchants in the travel industry.

14. The method of claim 8, wherein the override process comprises:
generating a table of transaction attributes that are specific to a merchant; and
searching for one or more matching transaction attributes in the one or more transaction strings.

15. A computer-implemented system for uniquely identifying a merchant from a transaction string transmitted by a payment network, the system comprising:
a database; and
a computer processor that is programmed to:
receive the transaction string from the payment network, the transaction string including merchant information;
automatically determine a most probable merchant name and at least one of a zip code, a phone number, merchant category code (MCC), and a physical address for the merchant based on data stored in the database;
execute an automated matching process to derive at least one of a name score, a zip score, a phone score, an MCC score, and a physical address score based on comparing internal merchant information with corresponding merchant information obtained from a third party data source of merchant information;
compute an overall matching score based on the name score, zip score, phone score, MCC score, and/or physical address score;
identify the merchant based on the highest probability of match with the third party data source;
link the merchant information from the transaction string to additional information from the third party data source on the merchant, wherein the additional information comprises information on corporate affiliates of the merchant; and
create a report containing the additional merchant information from the second data source based on uniquely identifying the merchant from the transaction string.

16. The system of claim 1, wherein the predefined threshold corresponds to a match score that is greater than 0.9.

17. The method of claim 8, wherein the predefined threshold corresponds to a match score that is greater than 0.9.
